(19) United States
(12) Patent Application Publication
(10) Pub. No.: US 2024/0372383 A1
(43) Pub. Date: Nov. 7, 2024

(54) METHOD AND DEVICE FOR NEAR FIELD COMMUNICATION WIRELESS CHARGING TRANSMITTER

(71) Applicant: STMicroelectronics International N.V., Geneva (CH)

(72) Inventors: Alexandre Tramoni, Le Beausset (FR); Christophe Grundrich, Grenoble (FR); Kosta Kovacic, Orehova vas (SI)

(21) Appl. No.: 18/634,476

(22) Filed: Apr. 12, 2024

(30) Foreign Application Priority Data
May 2, 2023 (FR) 2304401

(51) Int. Cl. H02J 7/00; H02J 50/20; H02J 50/80; H04B 5/79

(52) U.S. Cl. CPC H02J 7/0031; H02J 7/0047; H02J 50/20; H02J 50/80; H04B 5/79

(57) ABSTRACT

According to one aspect, a charging transmitter device is configured to carry out near-field wireless charging of a power receiver device, the charging transmitter device comprising a charging safeguarding circuit including a detection circuit configured to detect a movement of the power receiver device relative to the charging transmitter device, and a charging control circuit configured to stop charging when a movement of the power receiver device is detected.

### CROSS-REFERENCE TO RELATED APPLICATIONS

This application claims the benefit of French Patent Application No. 2304401, filed on May 2, 2023, which application is hereby incorporated herein by reference.

### TECHNICAL FIELD

Embodiments and implementations relate to near field communication technology, and more particularly to devices and methods for wireless charging using NFC technology.

### BACKGROUND

Wireless charging allows charging electronic devices without using any physical plugging.

Some wireless charging solutions use large antennas. The use of a large antenna to perform wireless charging limits the possible applications of this charging. These solutions cannot be used to charge small-size low-power electronic devices.

Wireless charging using NFC technology (acronym standing for “Near Field Communication”) has the advantage of being not very demanding in terms of space occupancy and allows using antennas on printed circuit boards.

Wireless charging using NFC technology allows carrying out charging of a wireless electronic device over a short distance, for example in the range of 10 cm.

NFC technology is an open technology platform standardized in the standard ISO/IEC 18092 and ISO/IEC 21481 but incorporates many already existing standards such as for example the type A and type B protocols defined in the standard ISO-14443 that may be communication protocols that can be used in NFC technology. Wireless charging using NFC technology is defined by the version 2.0 of the NFC WLC (“Wireless Charging”) specification published in October 2021 by the NFC Forum.

In particular, NFC wireless charging allows charging relatively small electronic devices, such as wireless headphones and smartwatches, fitness monitoring devices, or other electronic devices of the Internet of Things. For example, electronic devices may be charged by NFC wireless charging from a smartphone or from a dedicated charging station.

More particularly, NFC wireless charging is based on a charging transmitter device (also referred to as “poller”) and on a power receiver device (also referred to as “listener”). The charging transmitter is used to charge the power receiver.

In order to improve the energy transfer between the charging transmitter and the power receiver, an impedance matching circuit should be used. During charging, the impedance is matched when the power receiver faces the charging transmitter.

Nevertheless, such an impedance matching during charging involves a risk for the charging transmitter if the power receiver is moved by bringing it away from the charging transmitter during charging.

In particular, if the charging transmitter emits a power close to a maximum power when the power receiver is brought away from the charging transmitter then the impedance of the charging transmitter is no longer matched. This allows generating a charging signal having a high power which might heat up the charging transmitter, and even damage the charging transmitter.

In order to stop the generation of a charging signal with an excessively high power when the power receiver is brought away from the charging transmitter, it is possible to use temperature or current measurement means allowing detecting a rise in the temperature of the charging transmitter or a rise in the charging current generated in the charging transmitter.

These measurement means are then used to stop the generation of the charging signal when the temperature or the current of the charging signal exceed predefined thresholds. Nevertheless, using such measurement means, stopping the generation of the charging signal occurs at a late stage because the charging transmitter has already heated up.

Hence, there is a need to provide a solution allowing quickly and efficiently safeguarding the charging transmitter during charging of a power receiver.

### SUMMARY

According to one aspect, a charging transmitter device is provided configured to carry out a near-field wireless charging of a power receiver device, the charging transmitter device comprising a charging safeguarding circuit including:
a detection circuit configured to detect a movement of the power receiver device relative to the charging transmitter device,
a charging control circuit configured to stop charging when a movement of the power receiver device is detected.

Such a charging transmitter device allows stopping charging as of the first movements of the power receiver device when the latter is moved away from the charging transmitter device.

Hence, charging is stopped in an anticipated manner as of the first movements of the power receiver device to avoid generating a charging radiofrequency signal having a power that might damage the charging transmitter device.

Such an anticipated stoppage of charging allows increasing the service life duration of the charging transmitter.

In an advantageous embodiment, the charging transmitter device comprises an antenna configured, during charging, to emit a charging radiofrequency signal and to detect a radiofrequency signal outside the charging transmitter device, the detection circuit being configured to detect a movement of the power receiver device from the radiofrequency signal detected by the antenna.

Such a detection circuit is simple and inexpensive. Such a detection circuit may also be used to detect a near-field communication device proximate to the charging transmitter in order to start a near-field communication between the charging transmitter device and the near-field communication device.

Preferably, the detection circuit is configured to:
extract an amplitude and a phase of the radiofrequency signal detected by the antenna, then
detect a movement of the power receiver device relative to the charging transmitter device from a comparison between the extracted amplitude and phase and thresholds representative of such a movement, then
generate a detection signal when such a movement is detected.

Advantageously, the charging control circuit comprises a logic circuit configured to receive the detection signal and to stop charging when a movement of the power receiver device is detected.

In an advantageous embodiment, the charging transmitter device comprises at least one radiofrequency driver configured to generate the charging radiofrequency signal, the charging control circuit being configured to stop the radiofrequency driver when a movement of the power receiver device is detected by the detection circuit.

Advantageously, the charging transmitter device further comprises an impedance matching circuit between the at least one radiofrequency driver and the antenna, the impedance of the matching circuit being matched when the antenna of the power receiver is placed opposite and proximate to the antenna of the charging transmitter.

According to another aspect, a method for near-field wireless charging of a power receiver device from a charging transmitter device is provided, the method comprising implementing a charging safeguarding circuit of the charging transmitter during charging, the charging safeguarding circuit including:
a detection circuit configured to detect a movement of the power receiver device relative to the charging transmitter device,
a charging control circuit configured to stop charging when a movement of the power receiver device is detected.

In one embodiment, the method comprises:
detecting, by the detection circuit, a movement of the power receiver device relative to the charging transmitter device, then
stopping charging, by the charging control circuit, upon detection of the movement.

Advantageously, the method comprises:
extracting, by the detection circuit, an amplitude and a phase of the radiofrequency signal detected by the antenna, then
detecting a movement of the power receiver device relative to the charging transmitter device from a comparison between the extracted amplitude and phase and thresholds representative of such a movement, then
generating a detection signal when such a movement is detected.

Preferably, the method comprises, during charging, emitting, by an antenna of the charge emitter device, a charging radiofrequency signal and detecting, by this antenna, a radiofrequency signal outside the charge emitter device, the movement of the power receiver device relative to the charge emitter device being detected by the detection circuit from the radiofrequency signal detected by the antenna.

Advantageously, the method comprises receiving the detection signal, by a logic circuit of the charging control circuit, and stopping charging, by this logic circuit, when a movement of the power receiver device is detected.

In one embodiment, the method further comprises generating the charging radiofrequency signal by at least one radiofrequency driver, and stopping the radiofrequency driver, by the charging control circuit, when a movement of the power receiver device is detected by the detection circuit.

### BRIEF DESCRIPTION OF THE DRAWINGS

Other advantages and features of the invention will become apparent upon examining the detailed description of non-limiting embodiments, and from the appended drawings wherein:

FIG. 1 illustrates an embodiment near-field communication system;

FIG. 2 illustrates an embodiment charging transmitter; and

FIG. 3 illustrates a method for near-field wireless charging of a power receiver device from a charging transmitter device.

### DETAILED DESCRIPTION OF ILLUSTRATIVE EMBODIMENTS

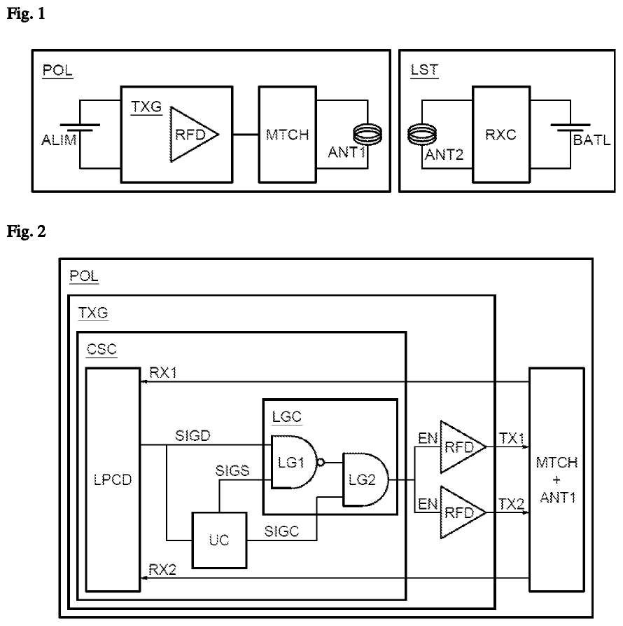

FIG. 1 illustrates an embodiment of a near-field communication system SYS. The system SYS comprises a charging transmitter device POL and a power receiver device LST.

In general, the charging transmitter POL is referred to by the expression “poller.” In general, the power receiver LST is referred to by the expression “listener.”

The charging transmitter POL is configured to charge the power receiver LST using NFC technology (acronym standing for “Near-Field Communication”).

For example, the charging transmitter POL may be a dedicated charging station or a smartphone.

The power receiver LST may be a relatively small electronic device, such as wireless headphones, a smartwatch, a fitness monitoring device, or another electronic device of the Internet of Things.

The charging transmitter POL comprises a charging signal generation circuit TXG. The charging signal generation circuit TXG includes a power supply ALIM and radiofrequency drivers RFD.

The charging transmitter POL also comprises an impedance matching circuit MTCH and an antenna ANT1.

The power receiver comprises a battery BATL, an antenna ANT2 and a receive circuit RXC.

The charging transmitter POL is adapted to charge the battery BATL of the power receiver LST when the antenna ANT2 of the power receiver LST is placed near and opposite the antenna ANT1 of the charging transmitter POL through an NFC charging.

NFC charging uses the electromagnetic induction generated from the charging transmitter POL to supply electricity to the power receiver LST in order to charge its battery BATL.

In particular, the radiofrequency drivers RFD (“radiofrequency (RF) drivers”) are configured to generate a charging signal to be transmitted to the antenna A2 of the power receiver LST through the antenna ANT1. The charging signal is generated from the power supply ALIM of the charging transmitter. The power supply ALIM may be a battery or a mains supply.

For example, the radiofrequency drivers may comprise amplifiers allowing generating the charging signal.

The radiofrequency drivers RFD are configured to operate in phase opposition according to a differential mode in order to improve the power of the charging signal. Alternatively, it is possible to use one single radiofrequency driver RFD for an asymmetrical operating mode (“single-ended mode”).

The antenna ANT1 of the charging transmitter POL is configured to generate an electromagnetic field corresponding to the charging signal generated by the radiofrequency drivers RFD.

The electromagnetic field then has a frequency in the range of 13.56 MHz and a root-mean square magnitude higher than 1.5 amperes/meter (i.e. “RMS” acronym standing for “Root Mean Square”), in particular comprised between 1.5 and 7.5 amperes/meter as defined by the standard ISO14443, and possibly higher than 7.5 amperes/meter as defined in the version 2.0 of the NFC WLC specification (“WireLess Charging”) published in October 2021 by the NFC Forum.

The antenna A2 of the power receiver is configured to receive the electromagnetic field emitted by the antenna ANT1 of the charging transmitter POL so as to receive the charging signal generated by the charging transmitter POL. Afterwards, this charging signal is transmitted to an NFC receiver circuit before supplying the battery BATL of the power receiver LST.

More particularly, NFC charging comprises a first phase in which the charging transmitter POL emits a relatively low electromagnetic field to carry out a negotiation with the power receiver LST. Once the negotiation is validated, the charging transmitter POL could emit the charging signal to charge the power receiver LST.

In order to improve the power transmitted between the charging transmitter POL and the power receiver LST, the antenna ANT1 and the antenna ANT2 are identical and the antenna ANT2 is placed opposite and proximate to the antenna ANT1 during NFC charging. For example, the antenna ANT2 is placed at a distance shorter than 5 mm, in particular by placing the power receiver LST against the charging transmitter POL.

The impedance matching circuit MTCH allows matching the impedance viewed by the radiofrequency drivers RFD. The impedance is matched when the power receiver LST is placed opposite and proximate to the charging transmitter POL.

FIG. 2 illustrates an embodiment of a charging transmitter POL in more details. In particular, the charging signal generation circuit TXG comprises a charging safeguarding circuit CSC. The charging safeguarding circuit CSC is configured to stop the generation of the charging signal as soon as the power receiver LST is moved relative to the charging transmitter POL.

The charging safeguarding circuit CSC comprises a detection circuit LPCD. For example, the detection circuit LPCD is an electronic circuit such as that one described in the European patent application having a publication number EP 3 672 091.

The detection circuit LPCD is configured to detect an amplitude and/or phase change in the radiofrequency signal RX1, RX2 sensed by the antenna ANT1 when the charging transmitter POL proceeds with charging of the power receiver LST.

The detection of an amplitude and/or phase change in the radiofrequency signal RX1, RX2 allows detecting a movement of the power receiver LST relative to the charging transmitter POL. When an amplitude and/or phase change is detected, then the detection circuit LPCD is configured to emit a detection signal SIGD.

Thus, the detection circuit LPCD is not only used to detect the presence of a power receiver LST at the beginning of the NFC communication but also to detect a movement of the power receiver POL relative to the charging transmitter LST.

More particularly, the detection circuit LPCD comprises a step-down converter IQ (also referred to as “In-Phase Quadrature (IQ) downconverter”) associated with low-pass filters so as to be able to convert a radiofrequency signal RX1, RX2 received from the antenna ANT1 into two continuous signals, respectively indicative of the amplitude and of the phase of the radiofrequency signal RX1, RX2. Alternatively, it is possible to provide for a detection circuit LPCD comprising an analog-to-digital converter to extract the amplitude and the phase of the radiofrequency signal RX1, RX2.

Afterwards, these continuous signals are compared with thresholds in order to detect amplitude and phase changes in the radiofrequency signal RX1, RX2 revealing the movement of a power receiver LST, notably in the electromagnetic field of the charging transmitter POL. These thresholds are defined during a calibration phase of the charging transmitter POL so as to be representative of a movement of the power receiver LST.

The calibration phase is carried out by placing a power receiver LST opposite the charging transmitter POL. These thresholds are independent of the thresholds that could be defined to detect the presence of a power receiver LST.

Once the NFC transmission is stopped, the charging transmitter POL may be configured to carry out a new probing phase so as to detect the presence of the power receiver LST to carry on charging of the power receiver POL.

The charging safeguarding circuit CSC comprises a logic circuit LGC. The logic circuit LGC comprises a NAND-type logic gate LG1 et an AND-type logic gate LG2.

The NAND-type logic gate LG1 has a first input connected to the detection circuit LPCD so as to be able to receive the detection signal SIGD and a second input configured to receive a state-of-charge signal SIGS allowing indicating whether charging is activated. The state-of-charge may be generated by a control unit UC of the charging transmitter POL. The NAND-type logic gate LG1 also has an output connected to a first input of the AND-type logic gate LG2.

The AND-type logic gate LG2 also has a second input configured to receive a control signal SIGC originating from the control unit UC. This control signal SIGC may be controlled from a software.

The AND-type logic gate LG2 has an output connected to the activation inputs EN of the radiofrequency drivers RFD.

The NAND-type logic gate LG1 and the AND-type logic gate LG2 allow activating or deactivating the radiofrequency drivers RFD under some conditions.

In particular, the radiofrequency drivers RFD are activated when an NFC transmission is desired, in particular for an NFC communication or for an NFC charging and when a power receiver LST is located proximate to the charging transmitter POL.

More particularly, the radiofrequency drivers RFD are activated only when the following conditions are met:
the NFC transmission is activated by the control signal SIGC, and
charging is activated when the power receiver is arranged proximate to the charging transmitter, i.e. when the state-of-charge signal SIGS is 1 and when the detection signal SIGD is 0.

The charging safeguarding circuit allows deactivating the radiofrequency drivers during charging if a movement of the power receiver relative to the charging transmitter is detected by the detection circuit. In particular, the detection circuit detects a movement of the power receiver when the amplitude and the phase of the radiofrequency signal RX1, RX2 exceed predefined thresholds.

Stopping the radiofrequency drivers RFD when a movement of the power receiver LST is detected allows stopping the NFC transmission when the power receiver LST is brought away from the charging transmitter POL.

In particular, bringing the power receiver LST away could cause a modification, in particular a decrease, in the impedance viewed by the radiofrequency drivers RFD of the charging transmitter POL.

The modification of this impedance could generate a radiofrequency signal having a power that might heat up the charging transmitter POL and even damage it, in particular by burning elements of the battery of the charging transmitter.

Stopping the NFC transmission achieved thanks to the safeguarding circuit CSC allows avoiding generating a radiofrequency signal TX1, TX2 having a relatively high power when the power receiver LST is too far away from the charging transmitter POL.

More particularly, the safeguarding circuit CSC allows stopping the generation of the radiofrequency signal TX1, TX2 as soon as the power receiver LST is moved and not when the power receiver LST is already too far away from the charging transmitter POL. Hence, stopping the generation of the radiofrequency signal TX1, TX2 is carried out in an anticipated manner in order to avoid heating up the charging transmitter POL.

Hence, such a safeguarding circuit CSC also allows improving the service life duration of the charging transmitter POL. Furthermore, such a safeguarding circuit CSC is inexpensive.

Of course, the present invention is open to various variants and modifications that would appear to a person skilled in the art. For example, instead of using the logic circuit LGC, stopping the radiofrequency drivers RFD may be controlled by the control unit UC as soon as a movement of the power receiver LST is detected. Nevertheless, the use of the logic circuit LGC allows stopping the radiofrequency drivers RFD more quickly compared to a digital control carried out by the control unit UC.

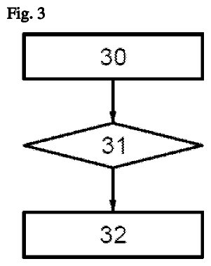

FIG. 3 illustrates an implementation mode of a method for near-field wireless charging of a power receiver device LST from a charging transmitter device POL, described before with reference to FIGS. 1 and 2.

The method comprises charging 30 the battery BATL of the power receiver from a charging radiofrequency signal generated by the charging transmitter POL.

In particular, charging comprises a first phase in which the charging transmitter POL emits a relatively low electromagnetic field to carry out a negotiation with the power receiver LST. Once the negotiation is validated, the charging transmitter POL could proceed with charging of the power receiver.

In particular, during charging of the power receiver, the radiofrequency drivers of the charging transmitter POL generate a charging radiofrequency signal TX1, TX2. This charging radiofrequency signal TX1, TX2 is transmitted to the antenna ANT1 of the charging transmitter POL via the impedance matching circuit MTCH.

Afterwards, the antenna ANT1 emits an electromagnetic field corresponding to the charging radiofrequency signal. Afterwards, this electromagnetic field is sensed by the antenna ANT2 of the power receiver which converts it into an electrical charging signal. Afterwards, this electrical charging signal is supplied to the battery BATL of the power receiver so as to charge it.

During charging, the method comprises a continuous control 31 of the amplitude and phase of the radiofrequency signal RX1, RX2 detected by the antenna ANT1 of the charging transmitter POL (step 31). This control 31 is carried out by the detection circuit LPCD of the charging safeguarding circuit CSC of the charging transmitter POL.

In particular, the amplitude and the phase of the radiofrequency signal RX1, RX2 are compared with thresholds representative of a movement of the power receiver LST relative to the charging transmitter POL. As indicated before, these thresholds are defined during a calibration phase of the charging transmitter POL so as to be representative of a movement of the power receiver LST.

If the detection circuit LPCD detects an amplitude and a phase higher than these thresholds representative of a movement of the power receiver LST relative to the charging transmitter POL, then the method comprises stopping 32 charging the power receiver. In this case, the radiofrequency drivers RFD of the charging transmitter are deactivated so as to stop the generation of the charging radiofrequency signal TX1, TX2. In particular, the radiofrequency drivers RFD are deactivated using the logic circuit LGC receiving the detection signal generated by the detection circuit LPCD.

If the detection circuit LPCD detects an amplitude and a phase lower than or equal to these thresholds, then charging of the power receiver could continue. In this case, the radiofrequency drivers RFD continue generating the charging radiofrequency signal TX1, TX2.

What is claimed is:

1. A charging transmitter device configured to carry out a near-field wireless charging of a power receiver device, the charging transmitter device comprising:
a charging safeguarding circuit including:
a detection circuit configured to detect a movement of the power receiver device relative to the charging transmitter device; and
a charging control circuit configured to stop the charging in response to detecting the movement of the power receiver device.

2. The charging transmitter device according to claim 1, further comprising:
an antenna configured to:
emit, during the charging, a charging radiofrequency signal; and
detect a second radiofrequency signal outside the charging transmitter device;
wherein the detection circuit is further configured to detect the movement of the power receiver device based on the second radiofrequency signal detected by the antenna.

3. The charging transmitter device according to claim 2, wherein the detection circuit is configured to:
extract an amplitude and phase of the second radiofrequency signal detected by the antenna;
detect the movement of the power receiver device relative to the charging transmitter device based on a comparison between the extracted amplitude and phase and thresholds representative of the movement; and
generate a detection signal in response to detecting the movement.

4. The charging transmitter device according to claim 3, wherein the charging control circuit comprises a logic circuit configured to:
receive the detection signal; and
stop the charging in response to detecting the movement of the power receiver device.

5. The charging transmitter device according to claim 3, further comprising:
at least one radiofrequency driver configured to generate the charging radiofrequency signal;
wherein the charging control circuit is configured to stop the at least one radiofrequency driver in response to the detection circuit detecting the movement of the power receiver device.

6. The charging transmitter device according to claim 5, further comprising:
an impedance matching circuit between the at least one radiofrequency driver and the antenna, wherein an impedance of the impedance matching circuit is matched based on the antenna of the power receiver device being disposed opposite and proximate to the antenna of the charging transmitter device.

7. The charging transmitter device according to claim 2, further comprising:
at least one radiofrequency driver configured to generate the charging radiofrequency signal;
wherein the charging control circuit is configured to stop the at least one radiofrequency driver in response to the detection circuit detecting the movement of the power receiver device.

8. The charging transmitter device according to claim 7, further comprising:
an impedance matching circuit between the at least one radiofrequency driver and the antenna, wherein an impedance of the impedance matching circuit is matched based on the antenna of the power receiver device being disposed opposite and proximate to the antenna of the charging transmitter device.

9. A method for near-field wireless charging of a power receiver device based on a charging transmitter device, the method comprising:
safeguarding, by a charging safeguarding circuit of the charging transmitter device, charging, the safeguarding comprising:
detecting, by a detection circuit of the charging safeguarding circuit, a movement of the power receiver device relative to the charging transmitter device; and
stopping, by a charging control circuit of the charging safeguarding circuit, the charging in response to detecting the movement of the power receiver device.

10. The method according to claim 9, further comprising, during the charging:
emitting, by an antenna of the charging transmitter device, a charging radiofrequency signal;
detecting, by the antenna, a second radiofrequency signal outside the charging transmitter device; and
detecting, by the detection circuit, the movement of the power receiver device relative to the charging transmitter device based on the second radiofrequency signal detected by the antenna.

11. The method according to claim 10, further comprising:
extracting, by the detection circuit, an amplitude and phase of the second radiofrequency signal detected by the antenna;
detecting the movement of the power receiver device relative to the charging transmitter device based on a comparison between the extracted amplitude and phase and thresholds representative of the movement; and
generating a detection signal in response to detecting the movement.

12. The method according to claim 11, further comprising:
receiving, by a logic circuit of the charging control circuit, the detection signal; and
stopping, by the logic circuit, the charging in response to detecting the movement of the power receiver device.

13. The method according to claim 11, further comprising:
generating, by at least one radiofrequency driver, the charging radiofrequency signal; and
stopping, by the charging control circuit, the at least one radiofrequency driver in response to detecting, by the detection circuit, the movement of the power receiver device.

14. The method according to claim 13, further comprising:
matching an impedance, by an impedance matching circuit between the at least one radiofrequency driver and the antenna, based on the antenna of the power receiver device being disposed opposite and proximate to the antenna of the charging transmitter device.

15. The method according to claim 10, further comprising:
generating, by at least one radiofrequency driver, the charging radiofrequency signal; and
stopping, by the charging control circuit, the at least one radiofrequency driver in response to detecting, by the detection circuit, the movement of the power receiver device.

16. The method according to claim 15, further comprising:
matching an impedance, by an impedance matching circuit between the at least one radiofrequency driver and the antenna, based on the antenna of the power receiver device being disposed opposite and proximate to the antenna of the charging transmitter device.

17. A charging transmitter device configured to carry out a near-field wireless charging of a power receiver device, the charging transmitter device comprising:
at least one radiofrequency driver configured to generate a charging radiofrequency signal;
an antenna configured to:
emit, during the charging, the charging radiofrequency signal; and
detect a second radiofrequency signal outside the charging transmitter device;
a detection circuit configured to:
detect a movement of the power receiver device relative to the charging transmitter device based on the second radiofrequency signal detected by the antenna; and
generate a detection signal in response to detecting the movement;
a charging control circuit configured to:
receive the detection signal; and
stop the charging in response to detecting the movement of the power receiver device.

18. The charging transmitter device according to claim 17, wherein the detection circuit is further configured to:
extract an amplitude and phase of the second radiofrequency signal detected by the antenna; and
detect the movement of the power receiver device relative to the charging transmitter device based on a comparison between the extracted amplitude and phase and thresholds representative of the movement.

19. The charging transmitter device according to claim 17, wherein the charging control circuit is further configured to stop the at least one radiofrequency driver in response to the detection circuit detecting the movement of the power receiver device.

20. The charging transmitter device according to claim 19, further comprising:
an impedance matching circuit between the at least one radiofrequency driver and the antenna, wherein an impedance of the impedance matching circuit is matched based on the antenna of the power receiver device being disposed opposite and proximate to the antenna of the charging transmitter device.
